(19) United States
(12) Patent Application Publication
(10) Pub. No.: US 2015/0332310 A1
(43) Pub. Date: Nov. 19, 2015

(54) PREDICTION OF ADVERTISEMENT REACH BASED ON ADVERTISER SPECIFIED BID AND/OR BUDGET AMOUNTS

(71) Applicant: Facebook, Inc., Menlo Park, CA (US)

(72) Inventors: Xinyi Cui, Menlo Park, CA (US); Wenjie Fu, Foster City, CA (US); Haomin Yu, Mountain View, CA (US); Ou Jin, Mountain View, CA (US); Eitan Shay, Palo Alto, CA (US); Richard Bill Sim, Belmont, CA (US); Jun Yang, Sunnyvale, CA (US)

(73) Assignee: Facebook, Inc., Menlo Park, CA (US)

(21) Appl. No.: 14/279,131

(22) Filed: May 15, 2014

(51) Int. Cl. G06Q 30/02; G06Q 50/00

(52) U.S. Cl. CPC G06Q 30/0242; G06Q 30/0246; G06Q 50/01; G06Q 30/0206

(57) ABSTRACT

An advertising system predicts advertisement reach for a received advertisement request based on an advertiser-specified bid amount and a specification of a target audience. The system samples the target audience, and for each sampled user of the target audience, accesses a recent impression history to obtain costs or bids associated with recent advertisement impressions. The system compares the advertiser-specified bid amount in the received advertisement request to costs or bid values associated with successful advertisement impressions, for each sampled user, in order to determine whether the received advertisement request would have won a bid auction for each given sampled user to successfully reach each given sampled user. An estimated aggregate reach for the sampled users is computed and extrapolated to the targeted user population to estimate a total reach of the advertisement content for the target audience.

### BACKGROUND

This disclosure relates generally to social networking systems, and more specifically to advertising via a social networking system.

Social networking systems, or social utilities that track and enable connections between users (including people, businesses, and other entities), have become prevalent in recent years and allow users to more efficiently communicate information with other users. Users, such as advertisers, may advertise their brands, products, events, or otherwise communicate and disseminate advertising content to other users via a social networking system. For example, advertising content provided to a user may include information indicating other users' interactions with the advertising content, in the form of stories that may be included in a newsfeed presented to the user.

Advertisers provide the social networking system monetary compensation in return for the social networking system circulating their advertising content to social networking system users. In order to reach a given user of the social networking system, advertisers frequently compete, in a bid auction, with other advertisers for advertisement space associated with the given user. Based on an advertiser-specified bid amount for given advertising content and other competing advertisement bids for the given user, specified advertising content may or may not reach the given user. Traditional methods for advertising via social networking systems, however, do not enable advertisers to estimate, based on a given bid amount, a measure or number of the targeted users that the advertising content will successfully be able to reach.

### SUMMARY

Methods and systems for online advertising predict an advertisement's reach, impressions, conversions, and/or cost based on an advertiser-specified bid amount, a specification of a target audience, and optionally an advertiser-specified budget in a received advertising request. To obtain the predictions, the system samples the target audience that is defined by the target specification. For each sampled user, the system accesses a recent impression history that contains information about a specified number of recent advertisement impressions. The system compares the advertiser-specified bid amount for the received advertising request to each of the impressions in the accessed impression histories for the sampled users. For each sampled user, the system determines whether the received advertising request would have won the advertisement auction in one or more of the impressions in the impression history. In some embodiments, the system compares the advertiser-specified bid values to the costs (e.g., ECPM values, or expected costs per thousand impressions) associated with winning bids corresponding to the one or more impressions. To do so, the advertisement system optionally normalizes or adjusts the costs associated with the winning bids by corresponding context scalars that modify or boost these costs based on a presentation context or based on the given user.

From this information, the system determines the total impressions and reach that would have occurred for the sampled users. The system then extrapolates these estimates of impressions and reach for the sampled population to obtain estimated aggregate impressions and reach of the advertisement for the total target audience defined by the targeting specification.

An advertiser may then use the estimated total reach of the advertisement content to adjust the bid amount, to adjust the specification of the target audience or any other suitable parameter specified in the advertising request to achieve a desired reach.

In some embodiments, methods and systems estimate a measure of outcome (conversions) for the advertisement content for the estimated number of impressions based on previously recorded or estimated conversion rates of similar advertisements or based on previously recorded or estimated conversion rates for the received advertisement content.

In some embodiments, a measure of reach for an advertisement represents an extent of circulation or dissemination of the advertisement among social networking system users—for example, as a total number of target users to whom the advertisement content was successfully presented. In some embodiments, a number of views or successful impressions or a number of successful results (e.g., wins) of bid auctions recorded for the advertisement represents a measure of exposure for the advertisement.

In some embodiments, a measure of conversion outcome for an advertisement represents a total number of user interactions or conversions of the advertisement content performed by users to whom the advertisement content was displayed or presented. Examples of conversion events include clicks on the advertisement, purchases of the advertised product or service, views of an advertiser's webpage provided in the advertisement, shares of the advertisement with other users, bookmark requests received for the advertisement, and the like.

The price charged to the advertiser for any given impression is optionally different from the winning bid value or cost associated with that impression and optionally different from the advertiser-specified bid value. In some embodiments, when an advertiser additionally specifies a budget, the measure of reach for the target audience is also impacted by the advertiser-specified budget. The total price charged to the advertiser is an aggregate of the prices charged for each individual impression. In such embodiments, the total reach of the advertisement content for the target audience is adjusted based on the budget specified in the advertisement request to limit a total price charged to the advertiser to the advertiser-specified budget.

The features and advantages described in the specification are not all inclusive and in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE DRAWINGS

FIG. 1 is a block diagram of a system environment in which a social networking system operates, in accordance with one embodiment.

FIG. 2 is a block diagram of a social networking system, in accordance with one embodiment.

FIG. 3 is a block diagram illustrating an advertisement system that includes an ad delivery and ad prediction system, according to some embodiments.

FIG. 4 is an example user interface illustrating an advertisement request provided by an advertiser at a social networking system, in accordance with some embodiments.

FIG. 5 is a flowchart of a method for estimating advertisement reach for a given target audience based on a specified advertisement bid amount, in accordance with one embodiment.

FIG. 6 is a flowchart of a method for providing an advertiser a bid-reach landscape for a given target audience as a representation of reach values corresponding to multiple bid amounts, in accordance with some embodiments.

FIGS. 7a-7f include example user interfaces illustrating bid-outcome landscapes and/or budget-outcome landscapes for various bid values and/or budget values, in accordance with some embodiments.

FIG. 8 is an illustration of impression histories of the sampled subset of users used to determine an expected reach and expected number of impressions for the sampled users of the target audience, in accordance with some embodiments.

FIG. 9 is an example illustration showing an extrapolation of a predicted reach from a sample of a target audience to a total reach for the target audience, in accordance with one embodiment.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

### System Architecture

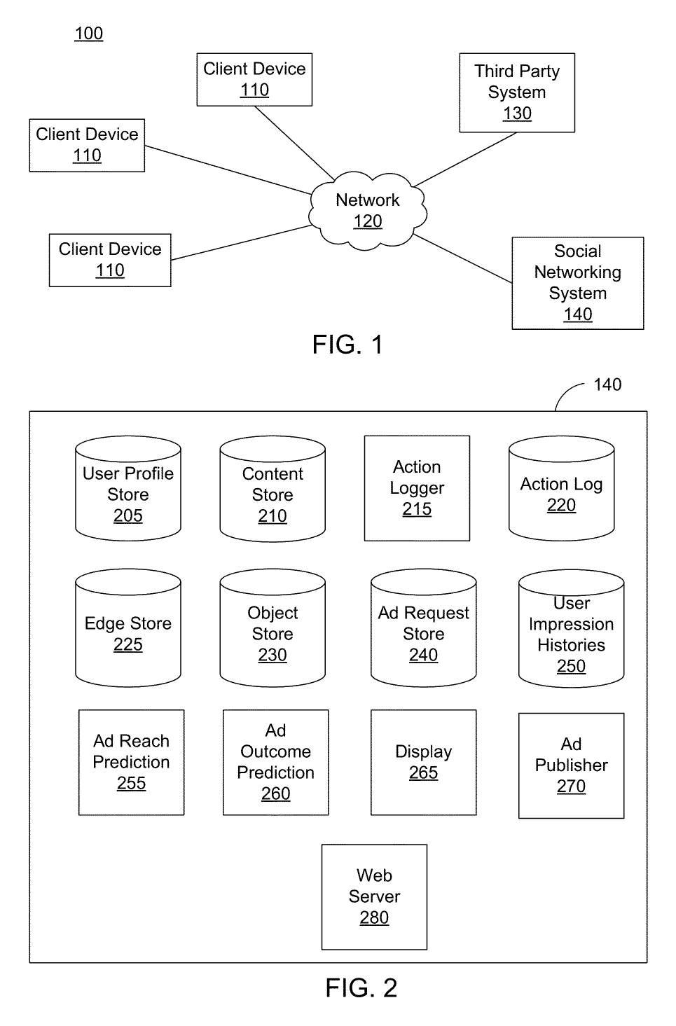

FIG. 1 is a high level block diagram of a system environment 100 for a social networking system 140. The system environment 100 shown by FIG. 1 comprises one or more client devices 110, a network 120, one or more third-party systems 130, and the social networking system 140. In alternative configurations, different and/or additional components may be included in the system environment 100. The embodiments described herein can be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the social networking system 140, which is further described below in conjunction with FIG. 1. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party website 130 may also communicate information to the social networking system 140, such as advertisements, content, or information about an application provided by the third party website 130.

FIG. 2 is an example block diagram of an architecture of the social networking system 140. The social networking system 140 shown in FIG. 2 includes a user profile store 205, a content store 210, an action logger 215, an action log 220, an edge store 225, an object store 230, ad request store 240, user impression histories store 250, ad reach prediction module 255, ad outcome prediction module 260, display module 265, ad publisher 270, and a web server 280. In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture.

Each user of the social networking system 140 is associated with a user profile, which is stored in the user profile store 205. A user profile includes declarative information about the user that was explicitly shared by the user and may also include profile information inferred by the social networking system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the social networking system 140, user profiles may also be stored for entities such as businesses or organizations. This allows an entity to establish a presence on the social networking system 140 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 210, such as status updates, photos tagged by users to be associated with other objects in the social networking system, events, groups or applications. In some embodiments, objects are received from third-party applications or third-party applications separate from the social networking system 140. In one embodiment, objects in the content store 210 represent single pieces of content, or content “items.” Hence, social networking system users are encouraged to communicate with each other by posting text and content items of various types of media to the social networking system 140 through various communication channels. This increases the amount of interaction of users with each other and increases the frequency with which users interact within the social networking system 140.

The action logger 215 receives communications about user actions internal to and/or external to the social networking system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the social networking system 140 to track user actions on the social networking system 140, as well as actions on third party systems 230 that communicate information to the social networking system 140. Users may interact with various objects on the social networking system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the social networking system 140 that are included in the action log 220 include: commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action log 220 may record a user's interactions with advertisements on the social networking system 140 as well as with other applications operating on the social networking system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the social networking system 140. For example, an e-commerce website may recognize a user of a social networking system 140 through a social plug-in enabling the e-commerce website to identify the user of the social networking system 140. Because users of the social networking system 140 are uniquely identifiable, e-commerce websites, such as in the preceding example, may communicate information about a user's actions outside of the social networking system 140 to the social networking system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page on the social networking system 140, sharing a link with other users of the social networking system 140, and commenting on posts made by other users of the social networking system 140.

In one embodiment, an edge may include various features each representing characteristics of interactions between users, interactions between users and object, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the social networking system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the social networking system 140 over time to approximate a user's interest in an object or another user in the social networking system 140 based on the actions performed by the user. A user's affinity may be computed by the social networking system 140 over time to approximate a user's interest for an object, interest, or other user in the social networking system 140 based on the actions performed by the user. Computation of affinity is further described in U.S. patent application Ser. No. 12/978,265, titled “Contextually Relevant Affinity Prediction in a Social Networking System,” filed on Dec. 23, 2010; U.S. patent application Ser. No. 13/690,254, titled “Updating Features Based on User Actions in Online Systems,” filed on Nov. 30, 2012; U.S. patent application Ser. No. 13/689,969, titled “Customized Predictors for User Actions in an Online System,” filed on Nov. 30, 2012; and U.S. patent application Ser. No. 13/690,088, titled “Dynamic Expressions for Representing Features in an Online System,” filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the advertisement request store 240. An advertisement request includes advertisement content and a bid amount. The advertisement content is text, image, audio, video, or any other suitable data presented to a user. In various embodiments, the advertisement content also includes a landing page specifying a network address to which a user is directed when the advertisement is accessed. The bid amount is associated with an advertisement by an advertiser and is used to determine an expected value, such as monetary compensation, provided by an advertiser to the social networking system 140 if the advertisement is presented to a user, if the advertisement receives a user interaction, or based on any other suitable condition. For example, the bid amount specifies a monetary amount that the social networking system 140 receives from the advertiser if the advertisement is displayed and the expected value is determined by multiplying the bid amount by a probability of the advertisement being accessed.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information, edges or actions satisfying at least one of the targeting criteria. Hence, targeting criteria allow an advertiser to identify users having specific characteristics, simplifying subsequent distribution of content to different users.

In one embodiment, the targeting criteria may specify actions or types of connections between a user and another user or object of the social networking system 140. The targeting criteria may also specify interactions between a user and objects performed external to the social networking system 140, such as on a third party system 130. For example, the targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in the targeting criteria allows advertisers to further refine users eligible to be presented with content from an advertisement request. As another example, targeting criteria may identify users having a connection to another user or object or having a particular type of connection to another user or object.

User impression histories store 250 maintains or stores information corresponding to advertisement bids that won against competing advertisement bids participating in bid auctions received for various social networking system users, for a specified interval of time. In some embodiments, such information stored by the user impression history store 250 includes identifiers for various advertisement requests received for the various social networking system users, and bid amounts for the various successful impressions or winning advertisement requests. In other words, the user impression history store 250 stores recent impression data corresponding to winning bids or bid auction results for the various social networking system users and monetary bid values (for example, ECPM values or values for expected costs per thousand impressions) corresponding to these winning bids.

Reach prediction module 255 estimates a total reach for a received advertisement request for a given target audience. Since a given advertisement request targeted to a specified user demographic may win bid auctions for presentation only to a subset of the targeted users, based on the bid amount specified in the advertisement request, reach prediction module 255 predicts or estimates an expected measure or number of targeted users to whom the advertisement request is likely to be presented for the specified bid amount. To do so, the reach prediction module estimates a measure or count of users, from a sampled subset of the targeted users, to whom the advertisement request would have reached. Then, the reach prediction module 255 extrapolates the reach count or measure from the sampled subset to the entire targeted population. Accordingly, reach prediction module 255 extracts a bid amount and a specification of a target audience for a received advertisement request (e.g., from the advertisement request store 240). Reach prediction module 255 defines a subset of users from the target audience (such as, by random sampling) and accesses an impression history (e.g., stored in the user impression history store 250) for each sampled user of the subset. Reach prediction module 255 compares the bid amount in the received advertisement request with bid amounts corresponding to recent advertisement impressions (or winning bids) stored in the impression history for each of the sampled user to determine whether the received advertisement request would have reached the sampled users. The reach prediction module 255 extrapolates the estimated reach for the sampled users to the target population to compute a total reach for the target population.

Not all users who view or are presented with advertisement content may interact with or perform a conversion event with the ad request. Examples of conversion events include clicking on the advertisement, purchasing the advertised product or service, viewing of an advertiser's webpage provided in the advertisement, sharing of the advertisement with other users, and bookmarking the advertisement. Advertisers may find value in accessing a measure of expected conversion outcome to evaluate how many of the targeted users within a demographic are expected to perform conversion events with their advertisement content, for a given bid amount. Thus, for a given advertisement request, the advertisement outcome prediction module 260 estimates an expected conversion outcome or a number of conversion events (e.g., a number of clicks, purchases, shares, bookmarks, etc. of advertisement content in the given advertisement request) for a target audience specified in the advertisement request. In some embodiments, the advertisement outcome prediction module 260 computes an expected conversion outcome for an advertisement request based on an estimated total reach for the target audience (obtained from the reach prediction module 255) and an empirical conversion rate for the advertisement request. The advertisement outcome prediction module 260 optionally computes the empirical conversion rate for the advertisement request based on recorded or estimated conversion rates for similar advertisements or based on prior conversion rates associated with the given advertisement request. For example, the advertisement outcome prediction module 260 may compute or access a number of users who previously performed conversion events when presented with the same or similar advertisements in order to estimate the empirical conversion rate.

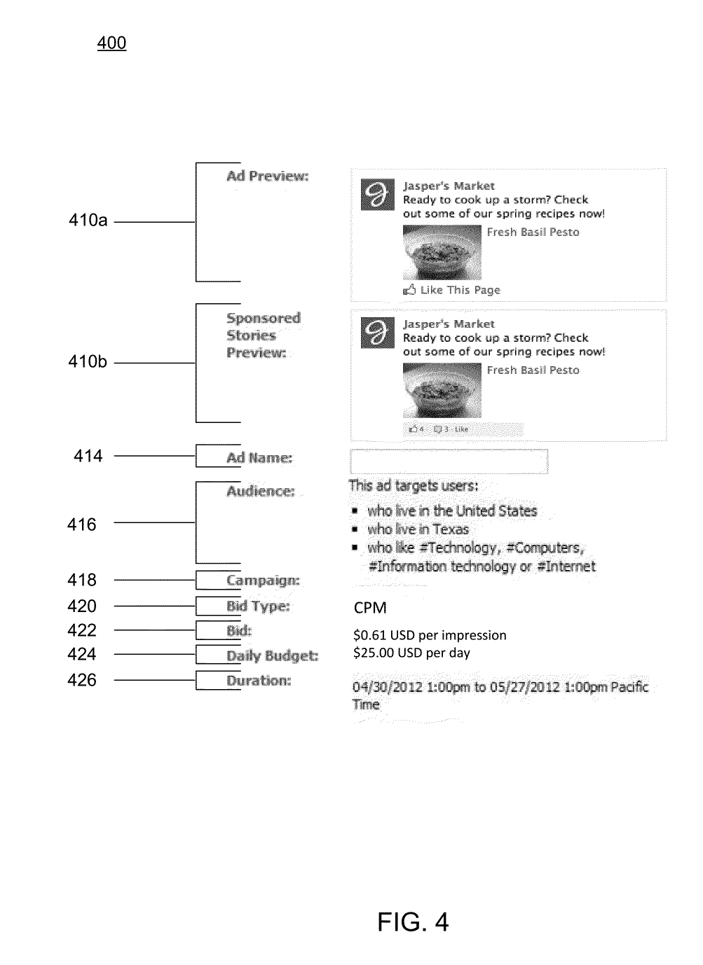

The display module 265 optionally formats content for display, prior to transmission to one or more client devices 110. Accordingly, display module 265 receives various processed, unprocessed, or stored information from one or more components of social networking system 140 and organizes, consolidates, modifies, and/or formats the information into a graphical user interface, or otherwise relays such received information for transmission to one or more client devices 110. Such information may include components of an advertisement request, including but not limited to advertisement content, a bid amount, targeting criteria, indicated budget, and time of rendering of the advertisement. An example of such a user interface is illustrated in FIG. 4. Similarly, the display module may format information computed by the reach prediction module 255 (e.g., a total reach for a received advertisement request for a given target audience) or by the advertisement outcome prediction module 260 (e.g., an expected conversion outcome or a number of conversion events) to a user at one or more of the one or more client devices 110.

The ad publisher 270 determines one or more scaling constants used to normalize, scale or adjust the bid amounts for the various advertisement requests by factors that depend on attributes of advertisement content in the various advertisement requests, attributes of a given user, and/or a context for the given impression of for presenting the advertisement content to the given user. Attributes of advertisement content include measures of quality, popularity, and the like. Examples of user attributes are personality, preferences, social context, connectivity, etc. Contexts include but are not limited to where the ad is to be displayed, such as in a mobile application, a mobile web page, or a desktop web page.

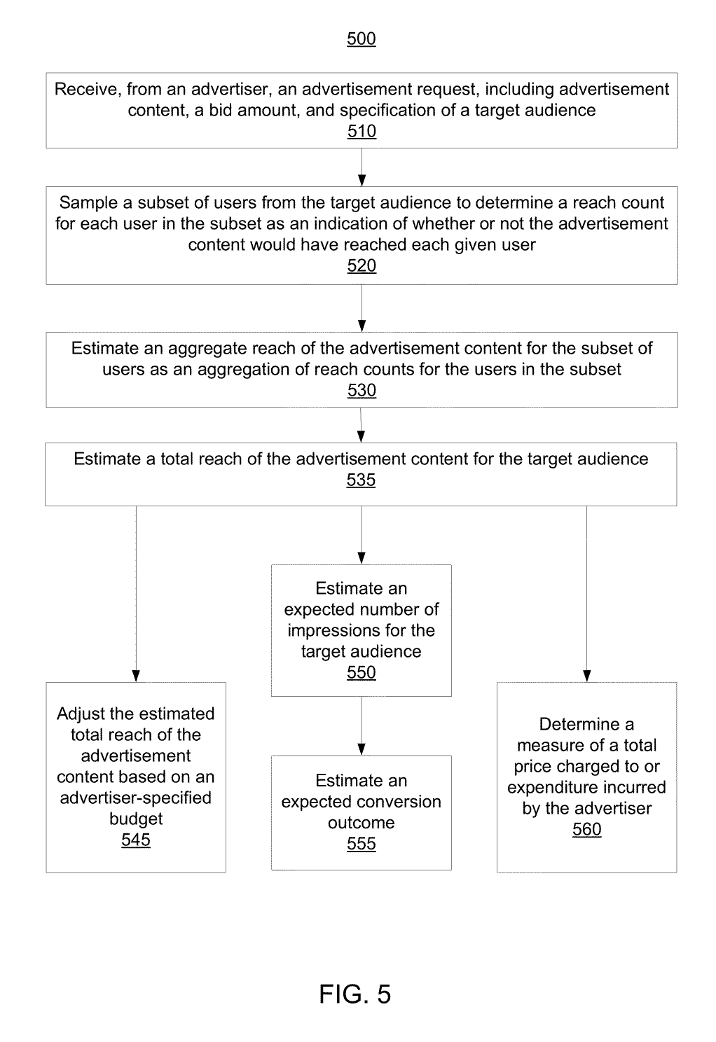

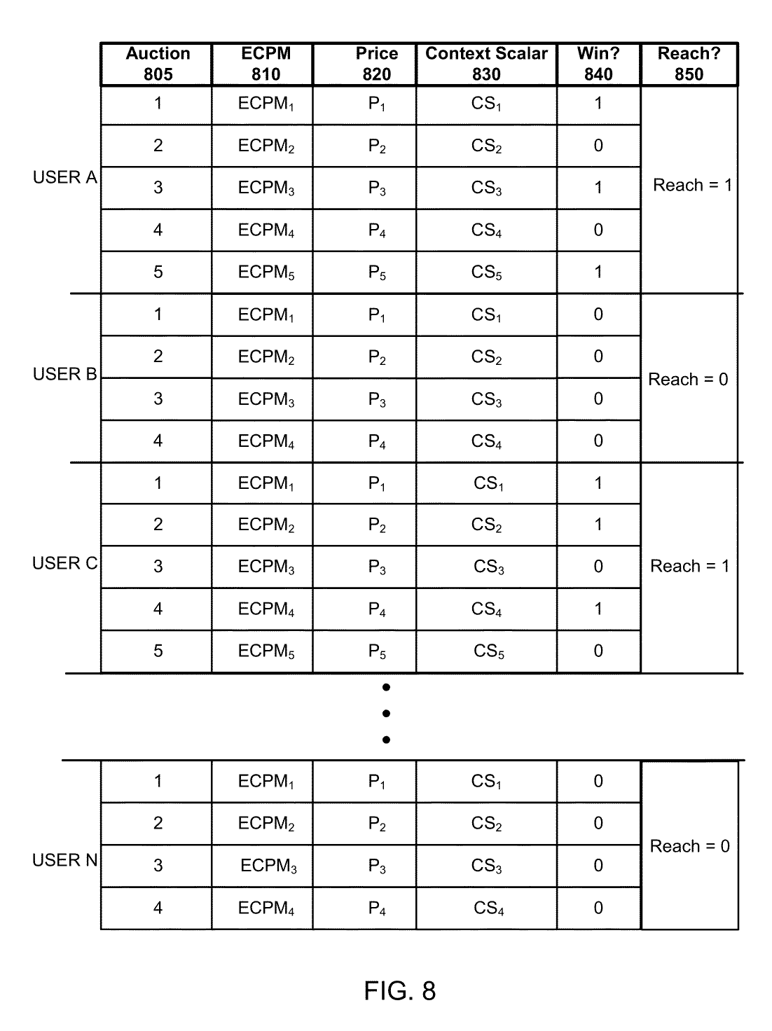

Accordingly, the ad publisher 270 estimates and stores a numerical context scalar associated with each of one or more social networking system users. In order to do so, for any given user, the ad publisher 270 selects a set of advertisements for display to the given user. For each of the selected advertisements, the ad publisher 270 calculates, retrieves, or otherwise obtains an expected click through rate that is independent of the user to whom the ad is displayed, or of the context under which the ad is displayed to the user. The ad publisher 270 also calculates an expected click through rate (eCTR) for the advertisement that is dependent on the user or context under which the ad is displayed to the user. The ad publisher 270 normalizes the user-context independent eCTR by the user-context independent eCTR to obtain the context scalar for the given user for the selected advertisement. The ad publisher 270 then obtains a median of these context scalars thus computed for each of the selected advertisements to obtain a context scalar for the given user and for the context underlying that impression for the given user. A more complete description of context scalars and this normalization process can be found below in conjunction with the discussion of FIGS. 5 and 8.

Additionally, the ad publisher 270 estimates and stores various parameters associated with one or more advertisements, such as the expected click through rates (eCTRs) for one or more of the advertisements, and expected conversion rates (eCVRs) for one or more of the advertisements. The ad publisher 270 may estimate or calculate the eCTRs or eCVRs for a given advertisement based on past clicks on the given advertisement or based on past conversions of the given advertisement. Alternatively, or in addition, the ad publisher 270 may estimate the eCTR or eCVR values for a given advertisement based on the past clicks on similar advertisements or based on past conversions of similar advertisements. In some embodiments, one or more other advertisements in the same advertisement campaign or advertisement group as the given advertisement are used as proxies for similar advertisements to the given advertisement.

The web server 280 links the social networking system 140 via the network 120 to the one or more client devices 110, as well as to the one or more third party systems 130. The web server 280 serves web pages, as well as other web-related content, such as JAVA®, FLASH®, XML and so forth. The web server 280 may receive and route messages between the social networking system 140 and the client device 110, for example, instant messages, queued messages (e.g., email), text messages, short message service (SMS) messages, or messages sent using any other suitable messaging technique. A user may send a request to the web server 280 to upload information (e.g., images or videos) that are stored in the content store 210. Additionally, the web server 280 may provide application programming interface (API) functionality to send data directly to native client device operating systems, such as IOS®, ANDROID™, WEBOS®, or BlackberryOS.

### Advertisement System Environments in a Social Networking System

Advertisers associated with a commercial entity, such as a product, service, brand, and the like, often seek to promote the entity to social networking system users. Advertisements describing a commercial entity may be created by an authorized user of the social networking system, such as a user with administrative permission to create content associated with a page in the social networking system that represents the commercial entity. Frequently, advertisers seek to promote an entity to social networking system users that have not previously interacted with the entity or a page associated with the entity, but that are likely to have an interest in the entity or in content describing the entity.

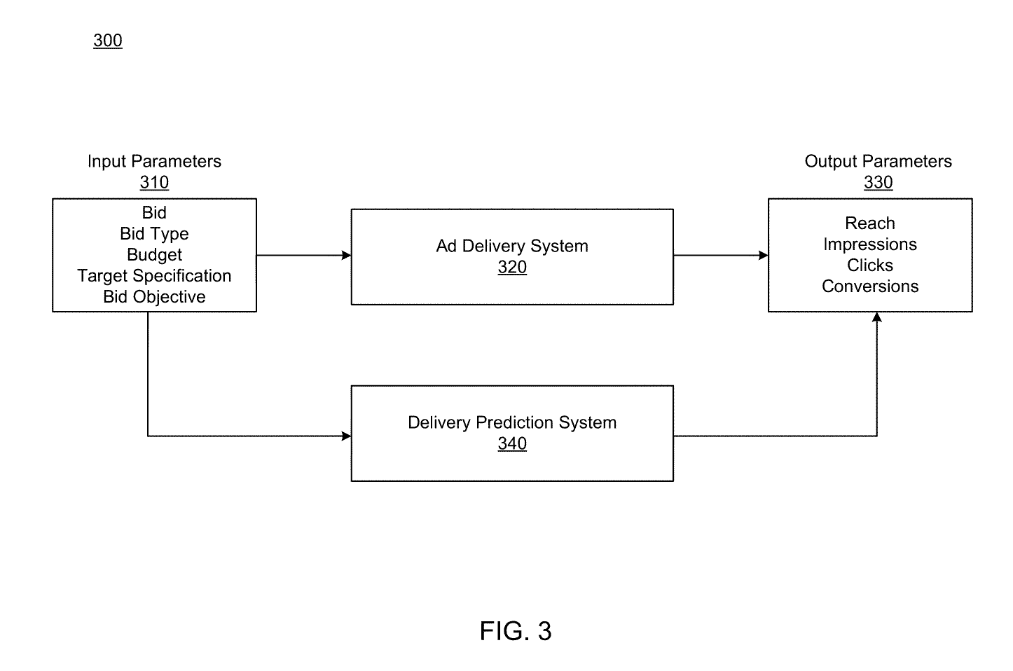

FIG. 3 includes a block diagram illustrating an advertisement system environment 300, according to some embodiments. Advertisement system environment 300 includes an ad delivery system 320 that receives an advertisement request from an advertiser and one or more input parameters 310 provided by the advertiser (such as a bid, a bid type, a budget, target specification, and bid objective) and associated with the advertisement request. In some embodiments, the advertisement request additionally includes advertisement content.

Advertisement content optionally includes advertising information about the commercial entity being advertised, e.g., information about social or community events associated with the entity, information or catalogues about products or services sold by the entity, and the like. Similarly, advertisement content may include educational information about the entity such as information about new products or services, new retail locations of the entity, etc. In some embodiments, advertisement content may include promotional offers such as product pricing information, service pricing information, discounts, and sales.

Advertisement content optionally includes text data, graphical data, video data, metadata, links to additional content (such as an advertiser's official product or service webpage), audio data, or any other suitable type of data. Advertisement content optionally includes information describing interactions performed or connections formed by one or more social networking system users with the entity being advertised in the advertisement request 400. For example, advertisement content may include a number of users who liked the advertisement content, a number of users who formed a connection with a page associated with the entity being advertised by the advertisement content, or a number of users who commented on the advertisement content.

Some online services adopt a bidding system that allows multiple advertisers to bid for an advertisement space for a given user or category of users. When competing advertisement bids are received for a particular advertisement space, to maximize advertisement revenue, an advertisement with the highest bidding price (e.g., in a bidding auction) is frequently selected and presented in the particular advertisement space to a viewing user. Commonly used bidding types include Cost Per Install (CPI), Cost Per Mille (CPM), Cost Per Click (CPC), and Cost Per Action/Acquisition (CPA) bids. The CPI-based and CPM-based pricing structures assess ad fees based on the number of instances an advertisement is presented or displayed to users. The CPC-based pricing structure assesses advertisement fees based on a number of clicks on the advertisement content by viewing users. The CPA-based pricing structure assesses ad fees based on a number of actions) taken by users that were presented with the advertisement content. In some embodiments, the actions taken into account for the CPA-based pricing structure include actions other than ad clicks; such as views of the product website, subscriptions to periodicals or newsletters associated with the advertiser, purchases of the advertised product, shares of the advertisement content, registration to the advertiser's service or product, conclusion of a sale of a service or product, etc. In some embodiments, the actions taken into account for the CPA-based pricing structure also include clicking on the advertisement. In some embodiments, the advertisement request includes bid amount indicative of an expected value, such as monetary compensation, provided by a corresponding advertiser to the social networking system if the advertisement is presented to a targeted user, if the advertisement receives a user interaction, or based on any other suitable condition.

The advertiser may further specify an advertisement budget that defines a monetary limit (e.g., an upper bound) for an amount of compensation the advertiser will provide to the social networking system for presenting the advertisement content to users of the social networking system 140. For each successful impression that is delivered to a viewing user, the advertiser is charged a certain price. This price may be different from (e.g., lower than) the advertiser-specified bid amount. In some embodiments, this price depends on other competing bids that participated in and were defeated in the bid auction. The total price charged to an advertiser for a specified number of impressions is a sum of prices associated with each of the impressions in the specified number of impressions. Thus, in such embodiments where the advertisement budget is specified, the total reach is impacted by the budget in order to limit the total price incurred for the total number of impressions based on the advertiser-specified budget.

The target specification includes information describing targeting criteria that are used to identify users of the social networking system 140 for presenting the advertisement content to; the identified users satisfying the targeting criteria. In other words, the specification of a target audience included in the advertisement request specifies one or more characteristics or attributes of users eligible to be presented with advertisement content in the advertisement request. Examples of targeting criteria included in the specification of a target audience 416 include: age, gender, location (e.g., work place, place of residence, home town, current location, etc.), hobbies or interests, broad categories (such as ethnicity, spoken languages, professional or occupational affiliations, other affiliations), or any other suitable demographic information.

Examples of these input parameters 310 in the context of an example advertisement request 400 are described with reference to FIG. 4.

The ad delivery system 320 processes the advertisement request and provides the advertisement content in the advertisement request to one or more social networking system users, based on the input parameters 310 specified in the advertisement request. The advertisement system environment 300 can measure one or more output parameters 330 (such as number of users reached, number of impressions, number of clicks, number of conversion events, and so on) resulting from delivery of the advertisement content based on the given input parameters 310.

In some embodiments, the advertisement system environment 300 includes a delivery prediction system 340 that estimates or predicts, a priori, values for one or more of the output parameters 330 based on the values of the input parameters 310 provided in the ad request, even before or without the advertisement content actually being delivered to social networking system users. The advertisement system environment 300 may provide the estimated or predicted values for the output parameters 330 to the advertiser for the given set of input parameters 310. Based on the estimated or predicted output parameters 330 the advertiser may request the advertisement system to proceed with delivery of the advertisement content to the one or more users of the social networking system based on the given set of input parameters 310. Alternatively, the advertiser may use the estimates of the output parameters 330 to modify one or more of the input parameters 310 with an objective to modify the one or more of the output parameters 330 that would result when the advertisement is actually delivered based on the modified input parameters.

In some embodiments, the advertisement system environment 300 provides the advertiser a bid-reach landscape for a given target audience as a representation of reach values corresponding to multiple bid amounts. In such embodiments, the advertisement system environment 300 may define a plurality of bid values and, for each bid value, estimate a corresponding reach value for the target audience as a number of the target users who are expected to be reached in the form of at least one successful impression based on each of the bid values. In alternative embodiments, the advertisement system environment 300 may define a plurality of bid-budget value pairs and for each bid-budget value pair, estimate a corresponding reach value for the target audience as a number of target users who are expected to be reached in the form of at least one successful impression based on each of the bid values and for a total reach cost for whom is expected to be lower than the corresponding budget value.

### Estimating or Predicting Advertisement Reach Based on an Advertisement Bid Amount

FIG. 5 is a flowchart of a method 500 for estimating advertisement reach for a given target audience based on an advertisement bid amount, according to one embodiment.

The social networking system receives 510, from an advertiser, an advertisement request, including advertisement content, a bid amount, and a specification of a target audience.

A subset of users is sampled 520 from the target audience to determine a reach count for each user in the subset as an indication of whether the advertisement content would have reached each given user. In some embodiments, the subset is sampled based on a predetermined sampling criterion, including a predetermined sampling rate and a predetermined threshold measure or proportion of users to be sampled. In some embodiments, a particular reach count recorded for a particular user in the subset indicates whether the advertisement content would have reached the particular user.

An actual example of impression histories for sampled users is shown and described below with reference to FIG. 8. In the example of FIG. 8, a reach count 850 is determined or recorded for each of the sampled users 1-N.

In some embodiments, the social networking system reviews an advertisement impression history for each given user in the subset based on a recency criterion, to determine whether the advertisement would have reached the given user. The social networking system reviews recent advertisement auction results or rankings for the given user based on a recency criterion to retrieve monetary costs associated with winning impressions or winning advertisement bids associated correspondingly with a plurality of impressions in the reviewed impression history. In some embodiments, the social networking system accesses recent auction results or rankings based on bids received for the given user within a predetermined interval of time (e.g., for the past day, past few hours, etc.) of reviewing or for a predetermined number of recorded bids corresponding to successful impressions (for the 100 most recent impressions, the 1,000 most recent impressions, and so on) for the given sampled user.

In some embodiments, prior to comparing the bid amount in the advertisement request to the retrieved costs, for each given user in the subset, the retrieved costs (e.g., winning bid value or ECPM) for the given user are scaled by context scalars representative of presentation contexts for those impressions. In some embodiments, the context scalar is indicative of one or more attributes of the advertisement content, one or more attributes of the given user, a context (that defines a user-access condition, such as mobile, desktop, etc.) for presenting the advertisement content to the given user, or any combination thereof.

Accordingly, in some embodiments, the social networking system computes a normalized or adjusted measure of the retrieved costs associated with the plurality of impressions in the reviewed impression history, by normalizing the retrieved costs (ECPM values) by a context scalar that provides a boost or modification based on a presentation context (e.g., based on the user, based on a location of ad placement, based on a type of computing device used to view the ad, and the like).

In some embodiments, the social networking system compares the bid amount in the advertisement request to the normalized or context-adjusted measure of the retrieved costs (the context normalized winning bid value or ECPM value), in order to determine a reach count for the given user. In some embodiments, the social networking system records a positive reach count for the given user if the bid amount in the advertisement request is greater than at least one of the normalized measures of the retrieved costs.

In some embodiments, if the bid amount in the advertisement request is equal to, substantially equal to, or infinitesimally greater than at least one of the costs or monetary values (e.g., context-normalized ECPM values) associated with the plurality of recent impressions for the user, then a positive reach count is recorded for the user (indicating a successful reach to the user). In other words, if the bid amount in the advertisement request beats or is greater than at least one of the bid values that won recent bid auctions for a given user, then content in the advertisement request is determined to have successfully reached or been presented to that given user had the advertisement request participated in those recent bid auctions.

The social networking system estimates 530 an aggregate reach of the advertisement content for the subset of users as an aggregation (or a sum) of reach counts for the users in the subset. The social networking system estimates 535 a total reach of the advertisement content for the target audience. In some embodiments, at least a portion of the estimated aggregate reach for the subset of users is extrapolated to the target audience, to estimate the total reach. In some embodiments, the total reach of the advertisement content for the target audience is estimated by extrapolating the estimated aggregate reach of the advertisement content for the subset of users, to the target audience.

In some embodiments, where the subset of users from the target audience are sampled based on a predetermined sampling criterion (the predetermined sampling criterion comprising a predetermined sampling rate and a predetermined threshold), the total reach of the advertisement content for the target audience is estimated based on the estimated aggregate reach of the advertisement content for the subset of users and the predetermined sampling criterion. In such embodiments, if the estimated aggregate reach for the subset of users exceeds the predetermined threshold, a portion of the estimated aggregate reach for the subset of users that exceeds the predetermined threshold is extrapolated, using the predetermined sampling rate, to obtain the total reach of the advertisement content for the target audience.

In some embodiments, the social networking system adjusts 545 the total reach of the advertisement content based on an advertiser-specified budget and the bid amount. Accordingly, in some embodiments, the advertisement request further comprises a specification of a budget (such as, specification of budget 424 in advertisement request 400) that limits an amount of compensation the advertiser provides to the social networking system for presenting the advertisement content to users of the social networking system. The total reach of the advertisement content for the target audience is adjusted based on the budget specified in the advertisement request and the bid amount. In some embodiments, total reach of the advertisement content is limited based on a budget-imposed cap to a reduced value within the upper bounds of the estimated total reach for the given bid amount, based on the specified budget. In other words, the total reach of the advertisement content for the target audience is adjusted based on the budget specified in the advertisement request to limit a total price charged to the advertiser for the adjusted total reach to the advertiser-specified budget.

In some embodiments, the social networking system estimates 550 a total number of impressions for the advertisement content audience. In some embodiments, a number of impressions is estimated for the subset of users as a total number of impressions or ad auctions in the reviewed impression histories for the sampled users for which the advertiser-specified bid amount exceeds a context-normalized retrieved cost (e.g., normalized ECPM).

In some embodiments, a total number of impressions for the target audience is estimated by extrapolating the number of impressions estimated for the subset of users to the target population.

In some embodiments, an expected conversion outcome for the target audience is estimated 555 based on the total number of impressions for the target audience and an empirical conversion rate (eCVR). In some embodiments, the empirical conversion rate for the target audience is determined based on a likelihood (or a statistically measured likelihood) of one or more users of the target audience performing a conversion event after being presented with the advertisement content. In some embodiments, the empirical conversion rate for the target audience is extrapolated from a statistical measure (maximum, mean, median, central value, or any other suitable measure) of conversion outcomes for the subset of users. In some embodiments, the empirical conversion rate is determined based on previously recorded conversion outcomes for the advertisement content—for example, based on previously measured or recorded click through rates for the advertisement content when previously displayed to social networking system users. In some embodiments, the previously recorded conversion outcomes are optionally adjusted based on conversion types for the recorded conversion outcomes (click on an ad, versus purchase of a product, versus share of an ad, versus visit or view a product webpage, versus subscribe to promotional information, etc.) to adjust the conversion outcomes for degrees of conversion interactions performed by social networking system users when presented with the advertisement content.

In alternative embodiments, the empirical conversion rate for the target audience is determined based on conversion outcomes (e.g., for the same or similar target audience) for one or more advertisements having content that shares one or more attributes with the advertisement content in the received advertisement request. For example, the empirical conversion rate is determined based on a measure of click through rate for advertisements that have content similar to the advertisement content in the ad request.

In some embodiments, the social networking system determines 560 a measure of a total price charged to or expenditure incurred by the advertiser. In order to do so, the social networking system optionally adds the prices that were charged to a corresponding advertiser for each ad auction that the advertisement request would have won to result in a successful impression.

### Obtaining Context Scalars and Normalizing ECPM Values Based on the Context Scalars

In some embodiments, estimation of advertisement reach for a given sampled user is further enhanced for improved estimation accuracy by adjusting a monetary value corresponding to a winning bid (e.g., the ECPM value) for each given sampled user with respect to factors such as attributes of the given sampled user and an environment defining or describing presentation circumstances of the advertisement content to the given sampled user, or any combination of these factors.

Accordingly, in some embodiments, the social networking system defines a context scalar (e.g., context scalar 830, shown in FIG. 8) to adjust or normalize a monetary value corresponding to a winning bid (e.g., ECPM value 810, shown in FIG. 8) for a given sampled user with respect to one or more attributes of the given sampled user or to adjust or normalize for presentation circumstances for a given impression.

Examples of such user attributes include demographic characteristics such as interests, indicators of personality, indicators of preferences such as prior advertisement impressions, prior advertisement conversions, social context and connectivity, etc. In such embodiments, the context scalar is a numerical value separately defined for each given sampled user and is used to adjust the ECPM value for each given sampled user to obtain an adjusted ECPM value for each given sampled user.

Alternatively, or in addition, the context scalar may be used to adjust or normalize an ECPM value for a given advertisement request with respect to one or more attributes of the given advertisement request. Such attributes optionally include a quality of the advertisement content, a popularity of the advertisement content, a nature of advertisement groups for the advertisement request, prior advertisement conversion rates or click through rates for the advertisement, etc. In such embodiments, the context scalar is a numerical value commonly defined for each sampled user and is used to adjust the ECPM value based on the specific advertisement request.

Furthermore, the context scalar may be used to adjust or normalize an ECPM value for a given advertisement request with respect to an environment defining or describing presentation circumstances of the advertisement content in the advertisement request to the given sampled user. Examples of presentation circumstances may include whether the advertisement is to be presented to the user on a mobile phone, on a desktop computer, location or placement of the advertisement for that impression, actions being performed by the user (e.g., viewing a post, viewing a picture, commenting on a post, and so on) on the social networking system during which the ad is displayed to the user, etc. In such embodiments, the context scalar is a numerical value separately defined for each given sampled user based on presentation circumstances for that given user, and is used to adjust the ECPM value for each given sampled user to obtain an adjusted ECPM value for each given sampled user.

In some embodiments, a context scalar is computed for each sampled user for each impression. In order to do so, the advertisement system selects a set of advertisements (e.g., M advertisements) for the given sampled user and ranks the M advertisements to select P of the M advertisements for display to the given user under a specified viewing or presentation circumstance (e.g., a predetermined advertisement placement or location, or for presentation to the given user while the user is performing a specified action such as viewing photos or commenting on posts, or while the user is viewing the advertisement using a specified computing device such as a mobile phone or a laptop or a desktop computer. For each of the K advertisements, the advertisement system obtains (e.g., computes or retrieves) two values of expected click through rates (eCTR)—one context and user independent and the other context and user dependent. For each of the K advertisements, the advertisement system computes a corresponding context scalar by normalizing the user-context dependent eCTR by the user-context independent eCTR. The advertisement system then computes a context scalar for the given user for the given impression (e.g., presentation circumstance) by computing a median of the K computed context scalars for the given user for the given presentation circumstance.

### Providing a Bid-Reach Landscape

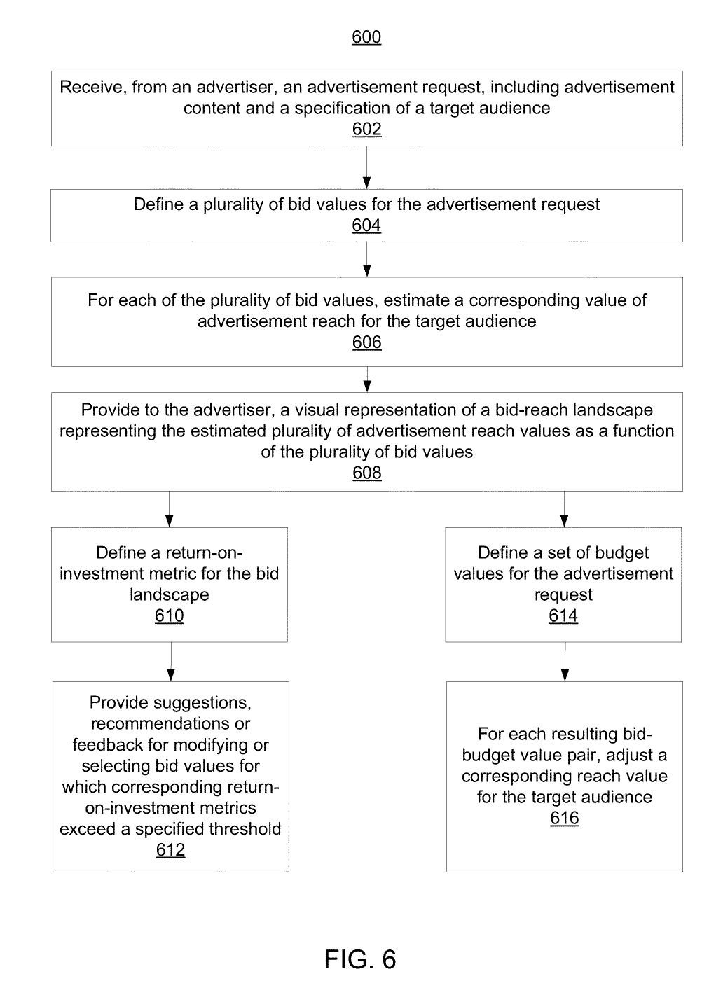

FIG. 6 includes a flowchart of a method 600 for providing an advertiser a bid-reach landscape for a given target audience as a representation of reach values corresponding to multiple bid amounts, in accordance with some embodiments.

The advertisement system receives 602 from an advertiser at a social networking system, an advertisement request. The advertisement request comprises advertisement content and a specification of a target audience for the advertisement content.

The advertisement system defines 604 a plurality of bid values for the advertisement request. For each of the plurality of bid values, the advertisement system estimates 606 a corresponding value of advertisement reach for the target audience. In some embodiments, the advertisement system estimates a value of advertisement reach for the target audience corresponding to each given bid value of the plurality of bid values by estimating a number of users of the target audience for each of whom the given bid value is expected to have resulted in at least one successful impression in a corresponding bid auction in a recent impression history. In such embodiments, the advertisement system estimates a number of users of the target audience for whom the given bid value is expected to have resulted in at least one successful impression in a corresponding bid auction by estimating a number of users of the target audience for each of whom the given bid value is expected to have been greater than a context-adjusted cost associated with at least one impression in the recent impression history, resulting in the at least one successful impression.

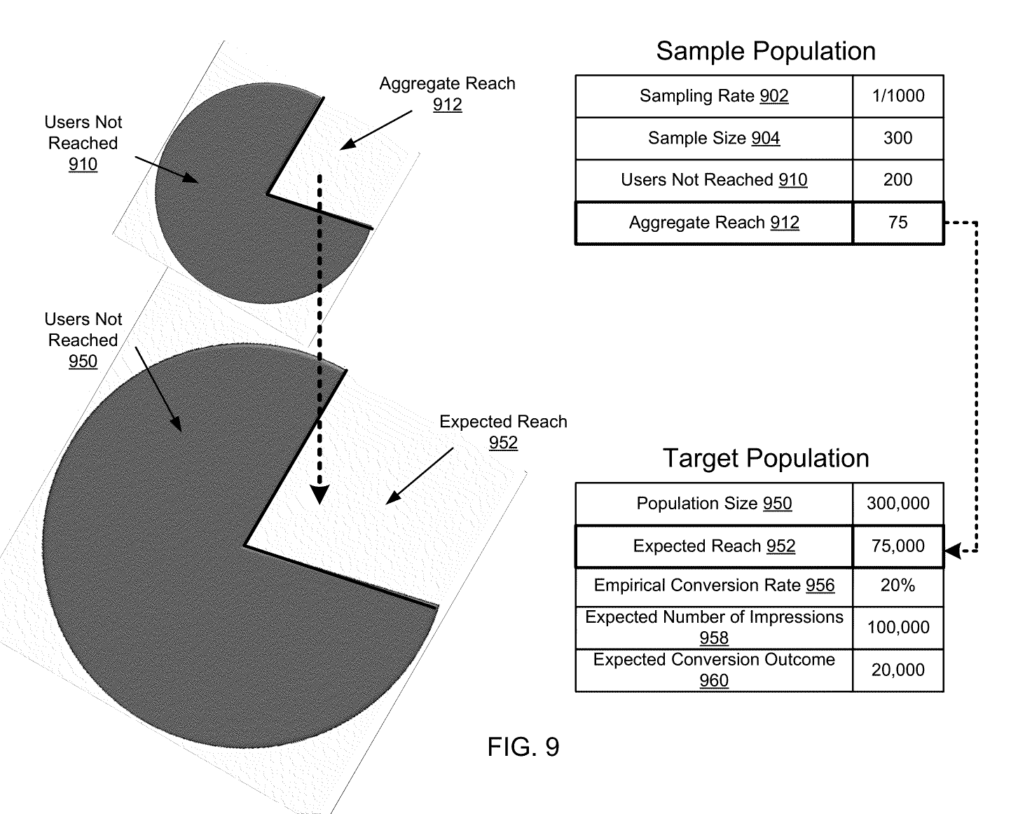

In some embodiments, the advertisement system estimates the corresponding values of advertisement reach for the target audience for each of the plurality of bid values based on the sampling and extrapolation approaches described with reference to method 500 (FIG. 5) and the illustrative examples of FIGS. 8-9. For example, the advertisement system samples a subset of users from the target audience to determine a reach count for each user in the subset, a particular reach count for a particular user in the subset indicating whether the advertisement content would have reached the particular user based on the given bid value. The advertisement system estimates an aggregate reach of the advertisement content for the subset of users as an aggregation of reach counts for the users in the subset. The advertisement system estimates a total reach of the advertisement content for the target audience for the given bid value by extrapolating the aggregate reach for the subset of users to the target audience.

In order to determine a reach count for each given user in the subset, in some embodiments the advertisement system reviews an advertisement impression history for the given user based on a recency criterion to retrieve costs associated correspondingly with a plurality of impressions in the reviewed impression history. The advertisement system computes normalized measures of the retrieved costs associated with each of the plurality of impressions in the reviewed impression history (e.g., adjusted or normalized ECPM values). The advertisement system compares the bid amount in the advertisement request to each of the computed normalized measures of the retrieved costs, in order to determine a reach count for the given user. The advertisement system records a positive reach count for the given user if the bid amount in the advertisement request is greater than at least one of the computed normalized measures of the retrieved costs.

In some embodiments, the advertisement system computes normalized measures of the retrieved costs (e.g., normalized or context-adjusted ECPM values) associated with each of the plurality of impressions in the reviewed impression history by scaling the retrieved costs or ECPM values associated with each of the plurality of impressions in the reviewed impression history for the given user by a corresponding scaling constant (e.g., a context scalar for the given user and given impression) indicative of: one or more attributes of the given user, a given presentation context for presenting the advertisement content to the given user for a given impression, or a combination thereof. In some embodiments, the corresponding scaling constant is determined for the given user for the given impression by presenting a set of advertisements to the given user under the given presentation context. Then, for each given presented advertisement of the set of advertisements, the advertisement system computes a user-context dependent expected click through rate for the given presented advertisement based on the given presentation context and the given user, retrieves a user-context independent expected click through rate for the given presented advertisement, and computes a scaling constant for the given presented advertisement by normalizing the user-context dependent expected click through rate by the user-context independent expected click through rate. The advertisement system computes the corresponding scaling constant as a median of computed scaling constants for the set of advertisements.

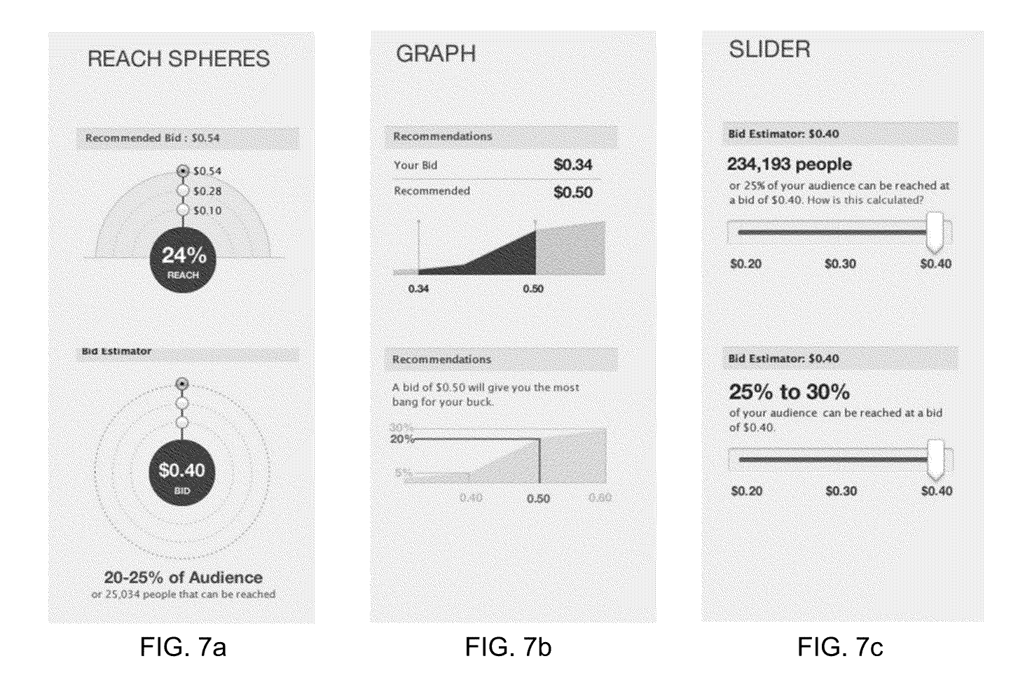

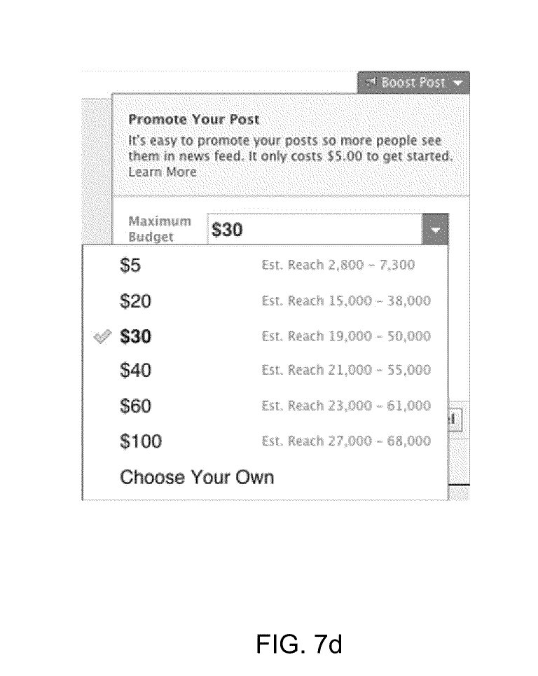

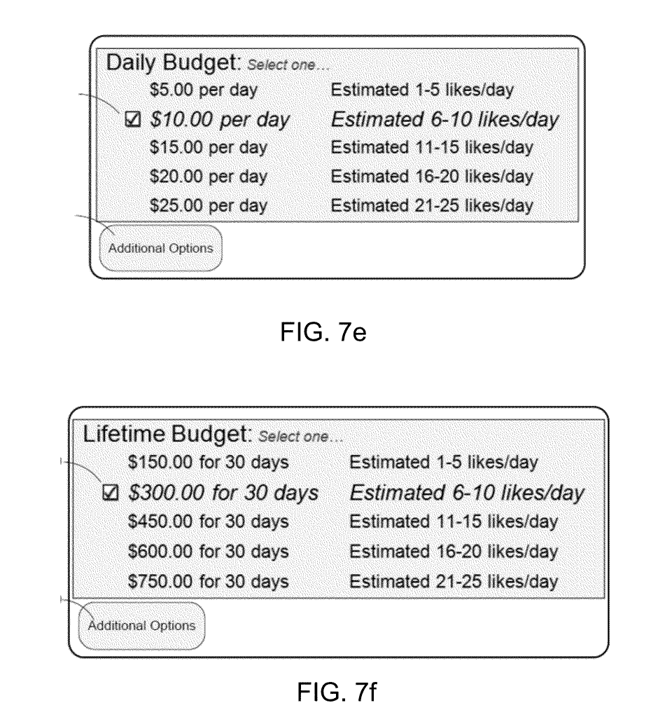

The advertisement system provides 608 to the advertiser, a visual representation of a bid-reach landscape representing the estimated plurality of advertisement reach values as a function of the plurality of bid values. Various example user interfaces may be used for the visual representation of the bid-reach landscape to depict the estimated plurality of advertisement reach values as a function of the plurality of bid values; some examples are shown in FIGS. 7a-7c.

In some embodiments, the advertisement system defines 610 a return-on-investment metric for the bid landscape, the return-on-investment metric representing incremental increases in reach values for corresponding increases in bid values. In such embodiments and as explained with reference to FIG. 7b, the advertisement system provides 612 the advertiser suggestions, recommendations or feedback for modifying or selecting bid values for which corresponding return-on-investment metrics exceed a specified threshold. For example, the advertisement system receives a selection, from the advertiser, of a specified bid value of the plurality of defined bid values, the advertisement system evaluates an efficacy of the specified bid value based on the return-on-investment metric and the specified bid value, and the advertisement system provides to the advertiser one or more suggestions for modifying the specified bid value based on the evaluated efficacy of the specified bid value. In alternative embodiments, the advertisement system directly provides, to the advertiser, one or more recommendations for bid values for which corresponding return-on-investment metrics exceed a specified threshold.

In some embodiments, the advertisement system additionally defines 614 a set of budget values for the advertisement request. In combination with the defined bid values (e.g., as explained with reference to step 604), the additional set of budget values result in a set of bid-budget value pairs. In such embodiments, for each resulting bid-budget value pair, the advertisement system adjusts 616 a corresponding reach value for the target audience to a maximum number of users for each of whom the given bid value is expected to have resulted in at least one successful impression in a bid auction and for whom a total reach price is expected to have been lower than the corresponding budget value.

### Effects of Bids and Budgets on Delivery Prediction

In some embodiments, the social networking system charges an advertiser a certain price for reaching a given user of an advertisement system for a given impression. In other words, when an advertiser wins a bid auction for a given user, the advertiser gets charged a certain price for that impression in lieu of the advertisement system presenting the advertiser's advertisement content to the given user. This price charged to the advertiser is optionally different from and frequently lower than a bid amount that the advertiser specifies in the ad request for that bid auction.

When the advertisement content reaches a plurality of users in the form of ad impressions displayed to the plurality of users, the advertisement system charges the advertiser a monetary amount equal to a sum of the prices associated with reaching each of those plurality of users. Accordingly, when the advertiser specifies an advertisement budget that defines a monetary limit (e.g., an upper bound) for an amount of compensation the advertiser provides to the advertisement system for presenting the advertisement content to users of the advertisement system, the advertisement system may limit the set of users that can be reached or may limit the set of impressions that can be achieved in order to keep the total price or expenditure for those impressions lower than the advertiser-specified budget.

In some embodiments, in limiting the set of users or the set of impressions in order to keep the total price or expenditure (incurred by the advertiser when reaching the set of users or in achieving the set of impressions) lower than the advertiser-specified budget, the advertisement system may determine that although certain users are possible to reach based merely on the advertiser's bid specification (e.g., users for whom ECPM or adjusted ECPM values corresponding to winning bids for recent impressions is lower than the advertiser's bid), those users may not be reached because a price associated with reaching those users would cause the total price charged to the advertiser to exceed the advertiser-specified budget. In some embodiments, therefore, the advertisement system may adjust the total reach (and the specific users reached or impressions achieved) for the advertisement content for the target audience based on the budget specified in the advertisement request so as to limit the total price for impressions achieved or users reached to the advertiser-specified budget.

Consider a numerical example for determining a measure of reach based on a combination of advertiser-specified bid and budget amounts. Assuming that monetary prices charged to an advertiser and adjusted ECPM values associated with reaching each of nine example users (Users 1-9) are: $0.3 for User 1, $0.2 for User 2, $0.3 for User 3, $0.4 for User 4, $1.2 for User 5, $1.1 for User 6, $1.4 for User 7, $2.7 for User 8, and $3.5 for User 9. In this example, assume also that the adjusted ECPM values corresponding to winning bids that resulted in successful impressions for these users are different from (e.g., higher than, for instance, by $0.1 in each case) the actual prices charged to the advertiser. The adjusted ECPM values for Users 1-9 are: $0.4 for User 1, $0.3 for User 2, $0.4 for User 3, $0.5 for User 4, $1.3 for User 5, $1.2 for User 6, $1.5 for User 7, $2.8 for User 8, and $3.6 for User 9.

In some embodiments, these prices may be measured, estimated, or otherwise determined based on past impression histories for each of those users. For example, these prices may correspond to prices charged to advertisers that won bid auctions for those users, resulting in successful impressions for those users. Alternatively, these prices may be a specified (e.g., a predetermined) amount higher or lower than bid amounts in ad requests that won bid auctions and resulted in successful impressions for those users. Alternatively, these prices may be obtained based on bid amounts for one or more ad requests that were defeated in the bid auctions for those users.

In this example, if an advertiser specifies a bid amount of $1.00 but does not specify a budget threshold, then the advertiser would be able reach any user for whom a reach price is below $1.00 (in this case, User 1, User 2, User 3, and User 4). The total expenditure in this case, for the advertiser, would be a total of the reach prices associated with these four users (0.3+0.2+0.3+0.4=$1.2). Note that for a bid of $1.0, the advertiser would not be able to reach Users 5-9, despite no budget specified constraints. On the other hand, if the advertiser additionally specifies a budget that is greater than or equal to the total reach price associated with reaching each user for whom an ECPM value or context-adjusted EPM value is lower than the advertiser-specified bid, then the advertiser would successfully reach each of those users for whom an ECPM value or context-adjusted ECPM value is lower than the advertiser-specified bid. In this example, for a specified budget greater than or equal to $1.2 (e.g., the budget of $2.0) and bid of $1.0, the advertiser would be able to reach User 1, User 2, User 3, and User 4. But if the advertiser-specified budget is lower than $1.2, the advertiser would not be able to reach all of the users (User 1, User 2, User 3, and User 4) for whom an ECPM value or context-adjusted ECPM value is lower than the advertiser-specified bid value of $1.00, but rather just a subset of these users—because a price associated with reaching all of these users (User 1, User 2, User 3, and User 4) would cause the price or expenditure incurred by the advertiser to exceed the advertiser-specified budget.

If the advertiser increased the bid to $2.0, with no budget constraints, the advertiser would additionally be able to reach User 5, User 6, and User 7 for whom the reach price is below $2.0—thereby increasing the reach count to 7 users. A total price or expenditure to the advertiser to now reach Users 1-7 would be $4.9 (0.3+0.2+0.3+0.4+1.2+1.1+1.4=$4.9). Thus, for a specified budget greater than or equal to $4.9 (e.g., the budget of $5.0) and bid of $2.0, the advertiser would be able to reach each of User 1, User 2, User 3, User 4, User 5, User 6, and User 7. However, a bid of $2.0 would be insufficient to reach User 8 and User 9, for whom adjusted ECPM values are higher than the specified bid of $2.0 ($2.7 for User 8 and $3.5 for User 9) and who are more expensive to reach than Users 1-7.

Similarly, an increased bid to $3.0 and an increased budget to $10 would additionally enable the advertiser to reach User 8, increasing the reach count to 8 users.

In some embodiments, as shown in the graphs of FIG. 7b, the reach percentage (e.g., the percentage of users from a target audience that can be reached) trends with or increases with increasing bid amounts, in the absence of advertiser-specified budget constraints. In some embodiments, an incremental increase in reach percentage decreases for higher reach percentages or higher bid amounts, resulting in diminishing returns for further increases in bid amounts (as seen from the plateauing of the reach-bid curves in FIG. 7b) over a specified bid threshold.

When budget constraints are also specified by an advertiser, the reach percentage levels off or is capped at a value of monetary spending (e.g., total price associated with reaching each of the users for whom an adjusted ECPM value is lower than the advertiser-specified bid amount) corresponding to the specified budget. This budget-dependent limit imposed on the reach measure prevents the monetary spending from exceeding the advertiser-specified budget. For example, for a budget specification of $20.00, the reach percentage may be capped or limited to a maximum reach measure (percentage) value of approximately 25% corresponding to a number of users for whom the total spending reaches $20. At this point, any further increase in the advertiser-specified bid amount will not result in an increase in reach percentage beyond the maximum budget-specified reach percentage value, unless the budget is also increased further. On the other hand, in this example, if the budget is increased to $50, the budget-dependent maximum reach percentage level or cap may increase to approximately 50%.

### Sampling a Target Audience to Estimate an Aggregate Reach for the Sampled Users

The likelihood of a social networking system user interacting with an advertisement associated with a commercial brand or entity may depend on one or more characteristics of the user. For example, female users under 40 years of age, living in San Francisco, may be highly likely to view and interact with an advertisement associated with a new women's clothing store in San Francisco. Advertisers therefore frequently wish to specifically target their advertisement content to users that have greater than a specified threshold or measure of likelihood of being interested in specific advertisement content. In some embodiments, targeting criteria are defined, for example, as one or more characteristics or attributes of users that have greater than a predetermined likelihood of interacting with given advertisement content. Examples of targeting criteria may include: age, gender, location (e.g., work place, place of residence, home town, current location, etc.), hobbies or interests, broad categories (such as ethnicity, spoken languages, professional or occupational affiliations, other affiliations), or any other suitable demographic information.

Furthermore, whether or not an advertisement is interacted with by a given user depends on whether or not the advertisement reaches the given user in the first place (e.g., in the form of a successful impression). Multiple advertisers frequently compete to advertise their brands to any given user via the social networking system—each advertisement competing in an auction, the results of which determine a winning advertisement that is then presented to the given user. Each advertisement competing in an auction for an advertisement space for a given user has a corresponding bid amount. Typically, an advertisement with a highest bid amount for a given user wins the bid auction for that given user and is presented to the given user.

Some users in the target audience may be more expensive to reach than others. Stated differently, some users of the target audience may receive advertisement bids that are higher in monetary bid value than other users of the target audience. Thus, a given advertisement bid that may be sufficiently high to reach a certain user (for whom the competing advertisement bids are lower than the given advertisement bid) may not be sufficient to reach another user (for whom one or more of the competing advertisement bids are higher than the given advertisement bid).

Accordingly, an advertiser may wish to estimate an expected reach or an expected measure of exposure for their advertisement content, given a specified bid amount. Expected reach or expected measure of exposure may be represented or measured as a number of users that an advertisement is likely to successfully reach. Furthermore, an advertiser may wish to estimate an expected reach for the advertisement, given a specified bid, for a specified target audience. In some cases, advertisers may use this information about the expected reach of an advertisement to adjust the bid amount, to adjust the specification of the target audience or any other suitable parameter specified in the advertisement request to appropriately adjust the expected reach to comport with a desired reach goal for the advertiser.

Corresponding to an advertisement request, targeted users are selected based on the specification of a target audience specified in the advertisement request. For instance, for the ad request 400 of FIG. 4, the target audience 416 selected includes users who live in Texas, who like or are interested in topics such as ‘Technology,’ ‘Computers,’ ‘Information Technology,’ or the ‘Internet.’

In some embodiments, the target audience is sampled (per step 520 of FIG. 5) based on a specified (e.g., predetermined) sampling criterion. In such embodiments, the target audience is sampled at a specified sampling rate of 1/M (where M is an integer or positive rational number)—such that, every Mth user of the target audience is sampled or selected for inclusion in the sampled subset. Alternatively, or in addition, a size of the selected subset is determined to be greater than a threshold sample size. For example, at least 10% of the users of the target population are sampled, or at least 1000 users from the target audience are sampled.

For each sampled user, the social networking system accesses an impression history. In some embodiments, as shown in FIG. 8, impression history for each user includes auction results or winning impressions from among advertisement requests that were received from one or more advertisers competing for advertisement space for presentation of their respective advertisement content to each sampled user.

FIG. 8 illustrates impression histories of various sampled users. In some embodiments, each winning advertisement request corresponding to a successful impression, for each sampled user, has an associated monetary cost corresponding to an advertiser's bid value or ECPM value (expected cost per thousand impressions illustrated as ECPM values 810). In some embodiments, the bid auctions order and rank the advertisement requests participating in the auction based on bid amounts specified in the ad requests for any given user—the highest monetary bid value for a given user is identified as the winning bid representing an advertisement request that won the bid auction 805 for that given user and advertisement content of which was selected for presentation to the given user in a successful ad impression. For each given user of the sampled subset of users, the social networking system identifies a winning bid and retrieves a corresponding winning monetary bid value as an ECPM (expected cost per mile) value for the given user and given impression.

The cost or monetary bid value (e.g., ECPM value) associated with a winning bid is optionally computed as a highest advertisement bid value received for a given user, for a given auction. In alternative embodiments, any other measure or numerical metric (e.g., any statistical measure such as or any variation of a central value, a median, a mean, a maximum value, within a specified range of a maximum value, a mode, or any other suitable measure) may be used to determine a winning bid for an advertisement bid auction for a given user; correspondingly, any other measure or numerical metric for cost or monetary bid value for the given user may be used as an ECPM value for the given user, for the given auction and given impression.

In some embodiments, the social networking system reviews or accesses impression histories, for the sampled subset of users, within a predetermined interval of time of reviewing e.g., for the past day, past few hours, etc. Alternatively, or in addition, the social networking system reviews or accesses impression histories, for a given user of the sampled subset of users, or for a specified (e.g., predetermined) number of recently recorded impressions (e.g., for the 100 most recent impressions) for the given user.

In some embodiments, the ECPM value for each user is an indication of how expensive it would be to reach the given user based on other advertisement requests that are also competing to reach that given user, and conversely whether an advertisement request with a specified bid value would be able to reach the user given the other competing advertisement bids for the given user.

With regard to the impression histories of sampled users shown in FIG. 8, a bid amount in the advertisement request is compared to the determined ECPM value 810 (e.g., the computed statistical measure or winning bid value of the competing bid values or costs) for each user of the subset of sampled users. In some embodiments, a context-based normalization is performed prior to the comparison. The ECPM value for each ad is divided or normalized by a context scalar 830 that is logged for that ad impression, for that user. In such embodiments, this normalized ECPM value is compared to the bid value for the ad to determine whether or not the ad would have won that bid auction and would have resulted in a successful impression.

For example, for an ad request, in order to determine whether the ad request would have resulted in a successful impression for auction 1, the bid amount in the ad request is compared to the ECPM value (to ECPM₁) corresponding to auction 1. In some embodiments, bid amount in the ad request is compared to the normalized ECPM value (to ECPM₁/CS₁) corresponding to auction 1. If bid amount is determined to exceed or be greater than ECPM₁/CS₁, then the advertisement system determines that the ad request would have successfully reached User A in auction 1. A positive win or impression count 840 (Win=1) is recorded for auction 1 for User A. On the other hand, if bid amount is determined not to exceed or be greater than ECPM₂/CS₂, then the advertisement system determines that the ad request would not have successfully reached User A in winning auction 2. A zero impression count 840 (Win=0) is recorded for auction 2 for User A.

Similarly, for User B, if bid amount is determined to be less than ECPM₁/CS₁ for User B, then the advertisement system determines that the ad request would not have successfully reached User A in auction 1. Similarly, for the example shown, bid amount is determined to be less than ECPM₂/CS₂ (auction 2) for User B, to be less than ECPM₃/CS₃ (auction 3) for User B, and ECPM₄/CS₄ (auction 4) for User B. Thus, the advertisement request is determined not to reach user B in any of the auctions 805 in User B's impression history.

If the ad request is determined to win one or more auctions for a given user, or is determined to result in at least one positive impression count for a given user, then the ad is determined to have reached the given user. In the example of FIG. 8, since the ad request is determined to have won auctions 1, 3, and 5 for User A, the ad request is determined to have reached User A. Accordingly, a positive reach count is recorded for User A. On the other hand, since ad request did not win any of the auctions (auctions 1, 2, 3, or 4) for User B, the ad request is determined not to have reached User B.

In some embodiments, a reach count 850 is recorded for each given user of the sampled subset based on whether the ad request would have reached the given user in at least one auction or would have defeated at least one ad request that resulted in a successful impression. For example, a positive reach count (e.g., a reach count of 1) is recorded for a given user if the bid amount in the advertisement request is greater than the normalized or adjusted ECPM value (a context normalized ECPM value) for at least one auction for the given user. Conversely, a zero reach count (e.g., a reach count of 0) is recorded for the given user if the bid amount 422 in the advertisement request is lower than the adjusted or normalized ECPM value (a context normalized ECPM value) for the given user for all of the auctions considered for the given user in order to determine a reach count for the given user.

Table 1 below includes illustrative numerical values corresponding to FIG. 8 for an impression history for User K of the N sampled users for a specified period of time (e.g., for the past 24 hours). In an example of a bid value of $0.61 per impression, this bid value ($0.61 per impression) is lower than the adjusted or normalized ECPM values for User K in the first, second, third, and fifth auctions of Table 1, the advertisement request would have been unsuccessful in beating the winning bids that resulted in successful impressions (e.g., Imp 1, Imp 2, Imp 3, and Imp 5) for those for User K and would not have reached User K in those ad auctions. As a result, win or impression counts 840 of value 0 are recorded for User K for the first, second, third, and fifth auctions.

On the other hand, since the bid value ($0.61) is greater than the adjusted or normalized ECPM value for User K in the fourth bid auction, the same advertisement request would have successfully won the fourth advertisement bid auction by defeating the winning bid that resulted in a successful impression (e.g., Imp 4) for the fourth auction and would therefore have reached User K in the fourth auction. Accordingly, a positive impression count 840 of value 1 is recorded for User K for the fourth auction.

TABLE 1
illustrating a recent impression history (with actual numerical values)
for User K of the N sampled users illustrated in FIG. 8

| Impression log or history | | | | |
|---|---|---|---|---|
| 805 (each row denoting an | | | Adjusted or | |
| impression that reached | | Context | Normalized | |
| User K by winning a | ECPMᵢ | scalar (CSᵢ) | ECPM | Win? |
| corresponding ad auction) | 810 | 830 | (ECPMᵢ/CSᵢ) | 840 |
| Imp 1 | $4.50 | 0.5 | $9.0 | 0 |
| Imp 2 | $3.20 | 0.9 | $3.55 | 0 |
| Imp 3 | $2.30 | 1.2 | $1.92 | 0 |
| Imp 4 | $1.15 | 2.08 | $0.55 | 1 |
| Imp 5 | $2.10 | 0.89 | $2.36 | 0 |

Since the ad request and the corresponding bid value as described in the above example are determined to have won at least one bid auction (e.g., auction 4) by defeating the winning bid or impression for that bid auction, the ad request is determined to have successfully reached User K. Accordingly, a positive reach count (reach count of value 1) would have been recorded for User K.

Although the impression counts and the reach counts recorded for the sampled users are described herein as numerical values indicative of whether an advertisement request would have resulted in successful impressions or reaches, respectively, for the sampled users, in practice, any measure of expected reach (e.g., a logic or Boolean value, capable of being set to true or false; a string or alphanumeric value; or any other suitable measure of expected reach) may be recorded for the sampled user based on whether or not the ad request would have reached the sampled user for a given bid amount in the ad request.

In some embodiments, per step 530 of FIG. 5, an aggregate reach (or an expected measure of advertisement exposure) for the sample population is computed by aggregating (e.g., accumulating or summing) reach counts for all of the sampled users to obtain a total count of sampled users that the advertisement content is expected to successfully reach for the specified bid value. Similarly, an aggregate impression count is computed for the sampled population by aggregating (e.g., accumulating or summing) impression counts or wins 840 for all of the sampled users to obtain a total number of successful impressions for the advertisement request for the sampled population.

Alternatively, or in addition, a total number of clicks and a conversion outcome for the sample population may be computed by multiplying or scaling the aggregate impression count for the sample population by a eCTR (or expected click through rate) or the eCVR (or expected conversion rate) for the advertisement request.

Extrapolating Estimated Reach from the Sampled Population to the Target Audience

In some embodiments, if a subset of users of a target population is randomly sampled from a target population, one or more statistical parameters or properties of the sampled subset of users are likely to be representative, in a statistical sense, of corresponding statistical parameters of the target population as a whole. Conversely, one or more statistical parameters of the target population as a whole may be estimated (e.g., extrapolated) from corresponding statistical parameters for the randomly sampled subset of the target population.

FIG. 9 depicts an example illustrating an extrapolation of an estimated or predicted reach from a sampled subset of a target audience to a total reach for the target audience, in accordance with some embodiments, per step 535 of FIG. 5. FIG. 9 is an example for estimating total reach (per step 535 of FIG. 5), total number of impressions (per step 550 of FIG. 5), and conversion events (per step 555 of FIG. 5).

In such embodiments, a sampling rate 902 is obtained from a specified or predetermined sampling rate that was used to select the sampled subset of users from the target population. In some embodiments, the sampling rate is calculated based on relative sizes of the sample population and the target population—as a ratio of sample size 904 to population size 950.

In some embodiments, per step 530 of FIG. 5, an aggregate reach 912 of the advertisement content for the sample population is obtained—as sampled users or a total number of sampled users for whom a positive reach count was recorded, as was described with reference to FIG. 8. Conversely, the users not reached 910 represent sampled users or a total number of sampled users for whom a zero reach count was recorded. Accordingly, expected reach 952 for the target population is computed, per step 535 of FIG. 5, based on an extrapolation of the aggregate reach 912—by multiplying aggregate reach 912 by an inverse of sampling rate 902 (e.g., 75*1000=75,000).

In some embodiments, when the advertisement system defines a plurality of bid values for the advertisement request (per step 604 of FIG. 6), the advertisement system estimates a total advertisement reach corresponding to each of the plurality of bid values (per step 606 of FIG. 6) by one or more of the sampling and extrapolation approaches described above with reference to the examples in FIGS. 8 and 9. In other words, for each of the plurality of bid values, the advertisement system may perform one or more of the steps of sampling the population (per step 520 of FIG. 5), estimating an aggregate reach for the sampled population (per step 530 of FIG. 5, and illustrative example of FIG. 8), and then extrapolating the aggregate reach for the sample population to the target population to obtain a total reach (per step 535 of FIG. 5, and illustrative example of FIG. 9).

In some embodiments, where the advertisement system estimates an aggregate number of impressions for the sampled population, the advertisement system may also extrapolate the aggregate number of impressions from the sampled population to a total expected number of impressions 958 for the target population (per step 550 of FIG. 5).

### Predicting a Conversion Outcome for the Advertisement Request for the Target Audience

If an advertisement is presented to a user, in spite of having viewed the advertisement, the viewing user may or may not interact with the advertisement or perform a conversion event such as a click on the advertisement, visit the advertiser's webpage or product page, purchase a product being advertised by the advertisement, and the like. As a result, a number of user interactions with or conversion events associated with an advertisement are typically lower than a number of user impressions or views of the advertisement—resulting, typically, in a certain amount of discrepancy between the number of impressions of the advertisement and a number of conversion events for the advertisement. Thus, over and above estimating a total reach for an advertisement, and a total number of impressions for the advertisement, an advertiser may wish to predict an expected conversion outcome 960 (e.g., an expected number of conversion events) for the advertisement for the target audience (per step 555 of FIG. 5).

In some embodiments, expected conversion outcome 960 is computed by multiplying expected number of impressions 958 for the target audience by an empirical conversion rate 956. In some embodiments, the empirical conversion rate is a measure of likelihood that one or more reached users of the target audience will perform a conversion event after viewing the advertisement. In some embodiments, the empirical conversion rate is an expected, predicted, or statistically measured conversion rate (or a click through rate), for the given advertisement and, optionally, for the given target audience.

In some embodiments, where the expected conversion rate is computed based on statistically measured or recorded conversion outcomes, the expected conversion rate is adjusted based on conversion types for the recorded conversion outcomes—a click on the ad, versus a view of the advertiser's webpage, versus conclusion of a purchase of an advertised product associated with the ad, versus a share of the advertisement content with other users of the social networking system, versus a bookmarking of the ad, and so on.

### Example of an Advertisement Request in a Social Networking System

FIG. 4 is an example user interface illustrating an advertisement request 400 provided by an advertiser associated with a commercial real-world entity, in a social networking system. Advertisement request 400 is an example of the advertising requests as received 510, 602 in the methods of FIGS. 5 and 6, respectively. As described with reference to FIG. 3 and as shown in FIG. 4, advertisement request 400 includes one or more input parameters defining the advertiser's specifications for rendering or presenting of the advertisement to users of the social networking system. Such parameters include advertisement content (e.g., illustrated within the content previews 410a and 410b, and optionally an advertisement name 414), a specification for a target audience 416, advertisement campaign information 418, an advertisement bid type 420, an advertisement bid amount 422, a specification for an advertisement budget 424, and optionally, timing information 426 for presenting or rendering of the advertisement to one or more users of the social networking system. The above-listed examples of parameters or components of an advertisement request are for purpose of explanation. The illustrative examples described herein are not intended to be exhaustive or to limit the embodiments to the precise forms disclosed. Many modifications and variations are possible, including the inclusion of one or more additional parameters not specifically listed or the exclusion of one or more of the above-listed parameters.

In some embodiments, the advertisement content is displayed to social networking system users in the form an advertisement separate from, but displayed alongside, a newsfeed presented to a viewing user (e.g., see preview 410a). In alternative embodiments, advertisement content in a social networking system is displayed in the form a sponsored story amidst other organic content within a newsfeed to a viewing user (e.g., see preview 410b). Advertisement content includes an advertisement name 414 or any other suitable identifier.

The specification of a target audience 416 includes information describing targeting criteria that are used to identify users of the social networking system 140 for presenting the advertisement content to; the identified users satisfying the targeting criteria. Examples of targeting criteria included in the specification of a target audience 416 include: age, gender, location (e.g., work place, place of residence, home town, current location, etc.), hobbies or interests, broad categories (such as ethnicity, spoken languages, professional or occupational affiliations, other affiliations), or any other suitable demographic information.

Various advertisement bid types (e.g., as noted in field 420) are used by advertisers to participate in an advertisement bidding auction for presenting their advertisement content to users of the social networking system.

The advertisement bid amount 422 is indicative of an expected value, such as monetary compensation, provided by a corresponding advertiser to the social networking system if the advertisement is presented to a targeted user, if the advertisement receives a user interaction, or based on any other suitable condition.

As shown, the advertisement budget 424 optionally specifies a limit for compensation that the advertiser desires to provide over a given period or duration of time (e.g., for an advertiser-specified number of hours, for a day, for an advertiser-specified number of days, etc.).

Timing information 426 is optionally provided by the advertiser, in the advertisement request 400, to specify a time and/or duration of rendering of the advertisement content to one or more users of the social networking system eligible to be presented with advertisement content in the advertisement request.

### Visual Representations of Bid-Reach Landscapes

In some embodiments, when the social networking system defines multiple bid values for the advertisement request (per step 604 of FIG. 6), the social networking system estimates or predicts reach measures (e.g., reach counts or percentage reach for a target audience, per step 606 of FIG. 6) corresponding to each of the multiple values. Optionally, the social networking system defines value combinations of bids and budgets, and estimates reach measures corresponding to the bid-budget value combinations (per steps 614 and 616 of FIG. 6). The social networking system then provides to the advertiser a visual representation of the bid-reach or bid-outcome landscape (per step 608 of FIG. 6) or a budget-outcome or a bid-budget-outcome landscape. These multiple values or value combinations of bids and budgets (per steps 604 and 614 of FIG. 6) may be predetermined or user-specified.

In such embodiments, the social networking system optionally presents these estimated reach measures for these multiple value combinations, to the advertiser—for example, in a tabular form, or graphically as illustrated in FIG. 7b. The advertiser may then select one of the values or value combinations of bid and/or budget in order to achieve the advertiser's desired delivery specification (e.g., a desired reach count or number of impressions or number of conversions, and so on).

Similarly, multiple reach measures may be provided to the advertiser as a function of bid values alone (e.g., as shown in FIGS. 7a-7c), either assuming no budget constraints or for a specified value of budget constraint. In some embodiments, the ad system computes or estimates a tuple <bid, cost, reach>, corresponding to value combinations of three parameters—bid, cost to advertiser, and total reach. In such embodiments, responsive to the advertiser choosing one of the three parameters, the ad system looks up the tuple combinations to identify a best estimate for one or both of the non-user specified parameters in the tuple. In alternative embodiments, the ad system predefines at least one of the parameters (e.g., the bid), looks up the tuple combinations to identify a best estimate for another one of the three parameters in the tuple (e.g., the cost), and then estimates the third parameter in the tuple (e.g., the reach).

In some embodiments, as shown in FIGS. 7a-7b, based on the multiple bid values considered and corresponding reach or outcome values computed, the advertisement system may provide the advertiser one or more recommendations for bid values that would result in a specified ad delivery efficacy. The ad system optionally defines a return-on-investment metric for the bid-outcome landscape (per step 610 of FIG. 6), the return-on-investment metric representing incremental increases in reach values for corresponding increases in bid values. For example, as shown in FIG. 7b, a $0.10 bid increase from $0.40 to $0.50 would result in a 15% increase in reach, but a subsequent $0.10 bid increase from $0.50 to $0.60 would merely result in a 10% increase in reach. If the advertiser specifies a bid value of $0.40, the advertisement system may recommend to the advertiser that a mere increase in bid value by $0.10 would provide a substantial (e.g., higher than a specified threshold) increase in reach measure. Accordingly, the advertisement system may recommend a bid value of $0.50 to the advertiser.

In some embodiments, the ad system receives a selection, from the advertiser, of a specified bid value of the plurality of defined bid values (e.g., $0.34 as illustrated in FIG. 7b) and evaluates an efficacy of the specified bid value based on the return-on-investment metric. The ad system then provides the advertiser one or more suggestions (e.g., a recommended bid value of $0.50) for modifying the specified bid value based on the evaluated efficacy of the specified bid value (per step 612 of FIG. 6).

Conversely, multiple estimated reach or other estimated outcome (e.g., conversion) measures may be provided to the advertiser as a function of budget values alone (e.g., as shown in FIGS. 7d-7f), either assuming no bid constraints or for a specified bid value.

### SUMMARY

The foregoing description of the embodiments has been presented for the purpose of illustration; it is not intended to be exhaustive or to limit the embodiments to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Some embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Some embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the embodiments be limited not by this detailed description, but rather by any claims that issue on an application based hereon. Accordingly, the disclosure of the embodiments are intended to be illustrative, but not limiting, of the scope of the embodiments, which is set forth in the following claims.

What is claimed is:

1. A method comprising:
receiving at a social networking system from an advertiser an advertisement request, the advertisement request comprising advertisement content, a bid amount for presenting the advertisement content to users of the social networking system, and a specification of a target audience for the advertisement content;
sampling a subset of users from the target audience to determine a reach count for each user in the subset, a particular reach count for a particular user in the subset indicating whether the advertisement content would have reached the particular user;
estimating an aggregate reach of the advertisement content for the subset of users as an aggregation of the reach counts for the users in the subset; and
estimating a total reach of the advertisement content for the target audience by extrapolating the aggregate reach for the subset of users to the target audience.

2. The method of claim 1, wherein determining a reach count for each given user in the subset comprises:
reviewing an advertisement impression history for the given user based on a recency criterion to retrieve costs associated correspondingly with a plurality of impressions in the reviewed impression history;
computing normalized measures of the retrieved costs associated with each of the plurality of impressions in the reviewed impression history;
comparing the bid amount in the advertisement request to each of the computed normalized measures of the retrieved costs, in order to determine a reach count for the given user; and
recording a positive reach count for the given user if the bid amount in the advertisement request is greater than at least one of the computed normalized measures of the retrieved costs, and a zero reach count for the given user if the bid amount in the advertisement request is lower than each of the computed normalized measures of the retrieved costs.

3. The method of claim 2, wherein computing normalized measures of the retrieved costs associated with each of the plurality of impressions in the reviewed impression history comprises:
scaling the retrieved costs associated with each of the plurality of impressions in the reviewed impression history for the given user by a corresponding scaling constant indicative of: one or more attributes of the given user, a given presentation context for presenting the advertisement content to the given user for a given impression, or a combination thereof.

4. The method of claim 3, wherein the corresponding scaling constant is determined for the given user for the given impression by:
presenting a set of advertisements to the given user under the given presentation context;
for each given presented advertisement of the set of advertisements:
computing a user-context dependent expected click through rate for the given presented advertisement based on the given presentation context and the given user,
retrieving a user-context independent expected click through rate for the given presented advertisement, and
computing a scaling constant for the given presented advertisement by normalizing the user-context dependent expected click through rate by the user-context independent expected click through rate; and
computing the corresponding scaling constant as a median of computed scaling constants for the set of advertisements.

5. The method of claim 1, wherein the total reach of the advertisement content for the target audience is estimated by extrapolating the estimated aggregate reach of the advertisement content for the subset of users, to the target audience.

6. The method of claim 1, further comprising:
computing, for the subset of users, a number of impressions for the advertisement content by:
reviewing an advertisement impression history for each sampled user based on a recency criterion to retrieve costs associated correspondingly with a plurality of impressions in the reviewed impression history;
computing normalized measures of the retrieved costs associated with each of the plurality of impressions in the reviewed impression history;
comparing the bid amount in the advertisement request to each of the computed normalized measures of the retrieved costs, in order to determine an impression count for each impression in the reviewed impression history; and
recording a positive impression count for a given impression if the bid amount in the advertisement request is greater than a computed normalized measure of the retrieved cost for the given impression, and a zero impression count for the given impression if the bid amount in the advertisement request is lower than the computed normalized measure of the retrieved cost for the given impression; and
estimating a number of impressions for the advertisement content for the subset of users as an aggregation of impression counts for the impressions in the impression history.

7. The method of claim 6, further comprising:
estimating a total number of impressions for the target audience by extrapolating the estimated number of impressions for the subset of users to the target population.

8. The method of claim 7, further comprising:
computing, for the target audience, an expected conversion outcome based on the estimated total number of impressions for the target audience and an empirical conversion rate for the advertisement content.

9. The method of claim 8, wherein the empirical conversion rate for the advertisement content is determined based on a likelihood of one or more users of the target audience performing a conversion event after being presented with the advertisement content.

10. The method of claim 8, wherein the empirical conversion rate for the target audience is extrapolated from a statistical measure of conversion outcomes for the subset of users.

11. The method of claim 8, wherein the empirical conversion rate is determined based on previously recorded conversion outcomes for the advertisement content.

12. The method of claim 11, wherein the previously recorded conversion outcomes are adjusted based on conversion types for the recorded conversion outcomes to adjust the conversion outcomes for degrees of conversion interactions performed by social networking system users when presented with the advertisement content.

13. The method of claim 8, wherein the empirical conversion rate for the target audience is determined based on conversion outcomes for one or more advertisements having content that shares one or more attributes with the advertisement content in the received advertisement request.

14. The method of claim 13, wherein the one or more shared attributes correspond to a common advertisement group, a common advertisement campaign, a common advertiser, or any combination thereof.

15. The method of claim 7, further comprising:
computing, for the target audience, an expected number of clicks based on the estimated total number of impressions for the target audience and an empirical click through rate for the advertisement content.

16. The method of claim 1, wherein:
the advertisement request further comprises indicated specification of a budget that limits an amount of compensation the advertiser provides to the social networking system for presenting the advertisement content to users of the social networking system; and
the total reach of the advertisement content for the target audience is adjusted based on the budget specified in the advertisement request to limit a total price charged to the advertiser for the adjusted total reach to the advertiser-specified budget.

17. The method of claim 1, wherein:
the subset of users from the target audience are sampled based on a predetermined sampling criterion, the predetermined sampling criterion comprising a predetermined sampling rate and a predetermined threshold; and
the total reach of the advertisement content for the target audience is estimated based on the estimated aggregate reach of the advertisement content for the subset of users and the predetermined sampling criterion by:
responsive to the estimated aggregate reach for the subset of users exceeding the predetermined threshold, extrapolating a portion of the estimated aggregate reach for the subset of users that exceeds the predetermined threshold, using the predetermined sampling rate, to obtain the total reach of the advertisement content for the target audience.

18. A computer system comprising:
a processor;
memory coupled to the processor, the memory having encoded thereon instructions that, when executed by the processor, cause the processor to:
receive from an advertiser at a social networking system an advertisement request, the advertisement request comprising advertisement content, a bid amount for presenting the advertisement content to users of the social networking system, and a specification of a target audience for the advertisement content;
sample a subset of users from the target audience to determine a reach count for each user in the subset, a particular reach count for a particular user in the subset indicating whether the advertisement content would have reached the particular user;
estimate an aggregate reach of the advertisement content for the subset of users as an aggregation of reach counts for the users in the subset; and
estimate a total reach of the advertisement content for the target audience by extrapolating the aggregate reach for the subset of users to the target audience.

19. A computer program product comprising a non-transitory computer-readable storage medium including instructions that, when executed by a processor, cause the processor to:
receive from an advertiser at a social networking system an advertisement request, the advertisement request comprising advertisement content, a bid amount for presenting the advertisement content to users of the social networking system, and a specification of a target audience for the advertisement content;
sample a subset of users from the target audience to determine a reach count for each user in the subset, a particular reach count for a particular user in the subset indicating whether the advertisement content would have reached the particular user;
estimate an aggregate reach of the advertisement content for the subset of users as an aggregation of reach counts for the users in the subset; and
estimate a total reach of the advertisement content for the target audience by extrapolating the aggregate reach for the subset of users to the target audience.
